(19) United States
(12) Patent Application Publication
(10) Pub. No.: US 2026/0237181 A1
(43) Pub. Date: Aug. 13, 2026

(54) Device, System and Method for Efficient Unmixing of Pixels in Hyperspectral Imagery

(71) Applicant: Geospatial Technology Associates LLC, Fernandina Beach, FL (US)

(72) Inventor: William F. Basener, Advance Mills, VA (US)

(21) Appl. No.: 19/049,282

(22) Filed: Feb. 10, 2025

(51) Int. Cl. G06V 10/58; G06V 10/766; G06V 10/776; G06V 20/10

(52) U.S. Cl. CPC G06V 10/58; G06V 10/766; G06V 10/776; G06V 20/194

(57) ABSTRACT

Embodiments of a system, method and device provide for unmixing every pixel in an image and identifying the materials present in each pixel. According to embodiments, at least one metric for each pixel in a spectral image is determined via a linear or nonlinear regression unmixing model, and for each spectrum in a spectral library, and for each pixel in the spectral image, a determination is made whether to reject the unmixing model based on the metric(s). Further, regions in the spectral image are defined for one or more spectra, where the regions are defined according to unrejected unmixing models.

### TECHNICAL FIELD

The present disclosure pertains to hyperspectral imagery, and more particularly to a device, system and method for unmixing of pixels in hyperspectral imagery.

### BACKGROUND AND SUMMARY

A hyperspectral image is a digital image with a spectrum for each pixel rather than just the three visual colors, red, green and blue (RGB). For most pixels, this spectrum is a measurement of multiple materials. Determining the mixture of materials present in a pixel with their relative abundances is called unmixing.

If the materials are known, then unmixing can be done with standard linear regression such as may be useful in manual processing of imagery. However, there are millions of pixels in a typical image, and the materials present in each pixel are not generally known beforehand. Moreover, there are hundreds or thousands of potential material spectra which may be represented in a spectral library, and determining which of these are present in a given pixel is difficult. Linear regression with a library of hundreds of spectra is a mathematically ill-posed problem requiring a division by zero to solve and does not provide accurate information.

It is known to employ endmember selection, whereby a set of perhaps ten pixels are chosen in an image representing pure materials, wherein every pixel in the image is unmixed using the endmembers, and endmembers are matched to spectra in a spectral library for identification purposes. It is also known to perform unmixing and identification of pixels scoring high in a target detection process, wherein the unmixing can be done using a large spectral library, but only for a region of interest from target detection. However, there are no current approaches that can identify and unmix every pixel in an image using a large spectral library.

Embodiments of the present disclosure provide a device, system and method for simultaneously unmixing every pixel in an image and identifying the materials present in each pixel.

### BRIEF DESCRIPTION OF THE DRAWINGS

FIG. 1 is a diagram of a system in accordance with embodiments of the present disclosure.

FIG. 2 is a process illustrating unmixing pixels from an image in accordance with embodiments of the present disclosure.

FIGS. 3 through 5 are graphical illustrations representing sample hyperspectral images.

### DETAILED DESCRIPTION OF EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or more than one of the described element. Thus, for example, reference to a pixel may encompass one or more pixels, a region may encompass one or more regions and so forth.

Embodiments described herein are specifically configured to provide a technical solution to a particular problem utilizing an unconventional combination of steps/operations to carry out aspects of the present disclosure. In particular, embodiments herein implement a unique combination of steps to provide a novel approach to unmixing pixels, including embodiments with notifications and user interface improvements.

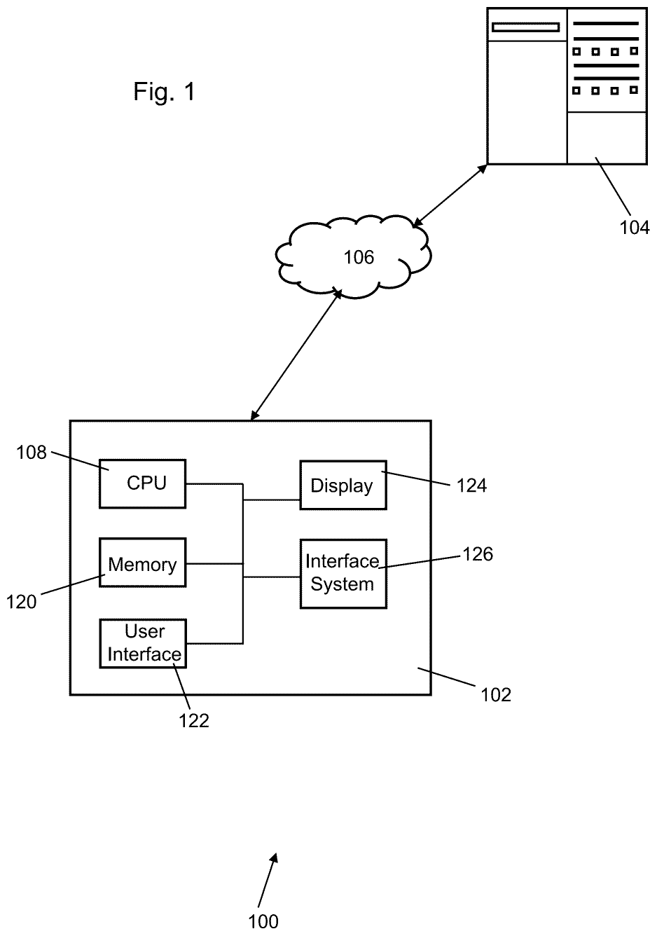

A system 100 with an exemplary image unmixing material identification processing apparatus 102 according to the present disclosure is illustrated in FIG. 1. The system 100 can include the apparatus 102 and a spectral image library server 104 coupled together by a communications network 106, although the environment can comprise other types and numbers of systems, devices, networks, and elements in other configurations. In various embodiments, server 104 can provide a spectral image library. The apparatus 102 can include one or more processors 108, at least one memory storage device 120, at least one user interface 122, at least one display 124, and at least one interface system 126 which are coupled together by bus or other link, although the device may comprise other types and numbers of elements in other configurations. In various embodiments, the user interface 122 and display 124 can be the same device. In various embodiments, memory 120 stores one or more spectral libraries and apparatus 102 need not be in communication with server 104.

The processor(s) 108 in the apparatus 102 executes a program of stored instructions for one or more aspects of the present disclosure as described and illustrated herein, although the processor could execute other numbers and types of programmed instructions. The memory storage device(s) 120 in the apparatus 102 stores these programmed instructions for one or more aspects of the present disclosure and can further store one or more spectral libraries as described and illustrated herein. It will be appreciated that some or all of the programmed instructions can be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor(s) 108 in the apparatus 102 can be used for the memory storage device(s) 120 in the apparatus 102.

The user interface(s) 122 in the apparatus 102 can be used to input selections and data, although the user input device could be used to input other types of information and interact with other elements. The user interface(s) 122 can include a computer keyboard and a computer mouse, although other types and numbers of user input devices can be used.

The display(s) 124 in the apparatus 102 is used to show images and other information to a user. The display(s) 124 can include a computer display screen, such as a CRT or LCD screen, although other types and numbers of displays can be used. The interface system 126 is used to operatively couple and communicate between the apparatus 102 and the spectral image library server 104 over the communication network 106, although other types and numbers of communication networks or systems with other types and numbers of connections and configurations to other types and numbers of systems, devices, and components can be used. By way of example only, the communication network can use TCP/IP over Ethernet and industry-standard protocols, including SOAP, XML, LDAP, and SNMP, although other types and numbers of communication networks, such as a direct connection, a local area network, a wide area network, modems and phone lines, e-mail, and wireless communication technology, each having their own communications protocols, can be used. In various embodiments, the spectral image library server 104 includes a central processing unit (CPU) or processor, a memory, and an interface or I/O system, which are coupled together by a bus or other link, although other numbers and types of network devices could be used. For example, the spectral images and/or image library can be stored in other types of storage or computing devices and the images can be obtained directly from image capture sensors or other storage devices. Generally, in this example the spectral image library server 104 processes requests received from the apparatus 102 via communication network 106 for images and signatures, although other types of requests for other types of data can be processed. The spectral image library server 104 may provide data or receive data in response to requests from the apparatus 102.

A spectral library according to the present disclosure can store material spectra for a large number of materials, including naturally occurring substances such as minerals and chemicals and artificial substances such as plastic, for example.

Although the apparatus 102 and image and spectral image library server 104 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any example. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

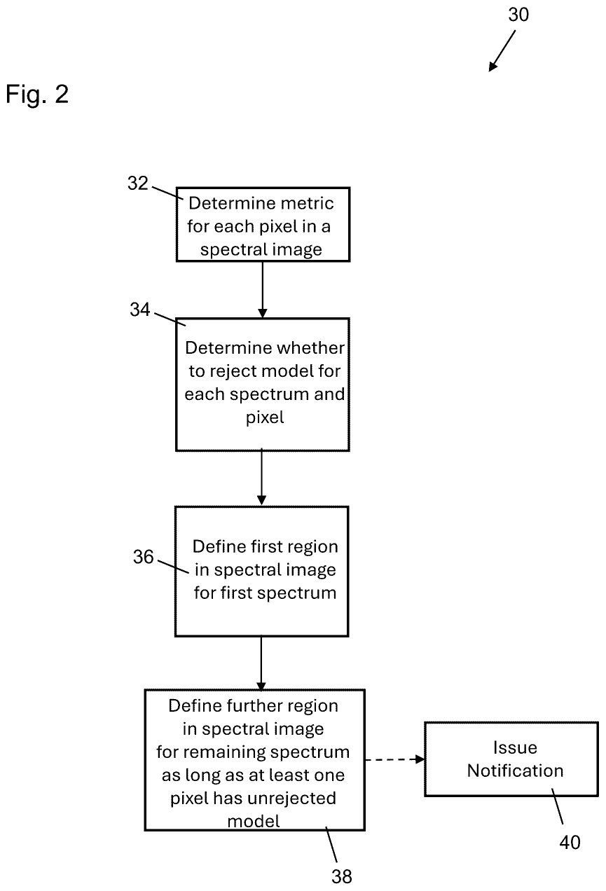

In diagram 30 of FIG. 2, various embodiments according to the present disclosure determine, as at 32, using a spectral library storing material spectra, at least one metric for each pixel in a spectral image. This determination can occur using a linear or nonlinear regression unmixing model executed on each pixel out of all of the pixels in the spectral image. It will be appreciated that the use of “unmixing model” herein when not otherwise specified can refer to a linear regression unmixing model, a nonlinear regressing unmixing model or other unmixing model. It will further be appreciated that the unmixing model can incorporate one or more spectra from the library. The metric can be a root mean square value, a likelihood value or other metric, for example. As at 34, for each spectrum in the library, and for each pixel in the spectral image, embodiments as disclosed herein determine whether to reject the unmixing model based on the stored metric. For example, if the unmixing model does not provide effective results, or assumed materials or abundances, or meet or exceed a known threshold, it can be rejected. As at 36, embodiments as disclosed herein define a first region in the spectral image for a first selected spectrum from the spectral library, wherein the first region includes at least one pixel in the spectral image having an associated unrejected unmixing model for the first selected spectrum. As at 38, for every remaining spectrum beyond the first selected spectrum from the spectral library, embodiments as disclosed herein define a further region in the spectral image as long as at least one pixel in the spectral image has an associated unrejected unmixing model and/or can be unmixed with an unrejected unmixing model, wherein the defined further region includes at least one pixel in the spectral image having the associated unrejected unmixing model for the remaining spectrum.

In various embodiments, an abundance of the first selected spectrum in each pixel of the first region is also determined. It will be appreciated that the metric can be a root mean square value and/or a likelihood value, for example. Determining whether to reject the unmixing model based on the stored metric in 34 can include comparing the stored metric for a first spectrum with the stored metric for a second spectrum. Further, determining whether to reject the unmixing model based on the stored metric in 34 can further include rejecting the unmixing model for the first spectrum if the stored metric for the first spectrum indicates a lower likelihood of the presence of the first spectrum than the metric for the second spectrum. Optionally, a notification of the identified material(s) from step 38 can be output in various forms as at 40, such as through an electronic communication and/or a display on user interface 122, display 124 or a separate computing device, for example. In various embodiments, a report or output can be, or can be included in, a notification over a network, such as an electronic communication to a communications device, such as a mobile communications device or other computing device.

It will be appreciated that one or more of the metrics for each pixel in the spectral image can be determined simultaneously according to various embodiments.

In addition to the above, embodiments of the present disclosure can define a sub-region of the first region for the first selected spectrum and a second selected spectrum from the spectral library, wherein the sub-region includes at least one pixel in the spectral image having an associated unrejected unmixing model for the first selected spectrum and the second selected spectrum. In such embodiments, an abundance of the first selected spectrum and the second selected spectrum in each pixel of the sub-region can be determined.

In various embodiments, additional actions can include determining, using the material spectra in the spectral library other than the first selected spectrum and the second selected spectrum, at least one metric for each pixel in the sub-region using an unmixing model executed on each pixel of the sub-region. Further, additional actions can include, for each spectrum of the plurality of material spectra in the library other than the first selected spectrum and the second selected spectrum, and for each pixel in the plurality of pixels in the sub-region, determining whether to reject the unmixing model based on the stored at least one metric. Embodiments can further include defining a partial region of the sub-region for the first selected spectrum, the second selected spectrum and a third selected spectrum from the spectral library, wherein the partial region includes at least one pixel in the spectral image having an associated unrejected unmixing model for the first selected spectrum, the second selected spectrum and a third selected spectrum.

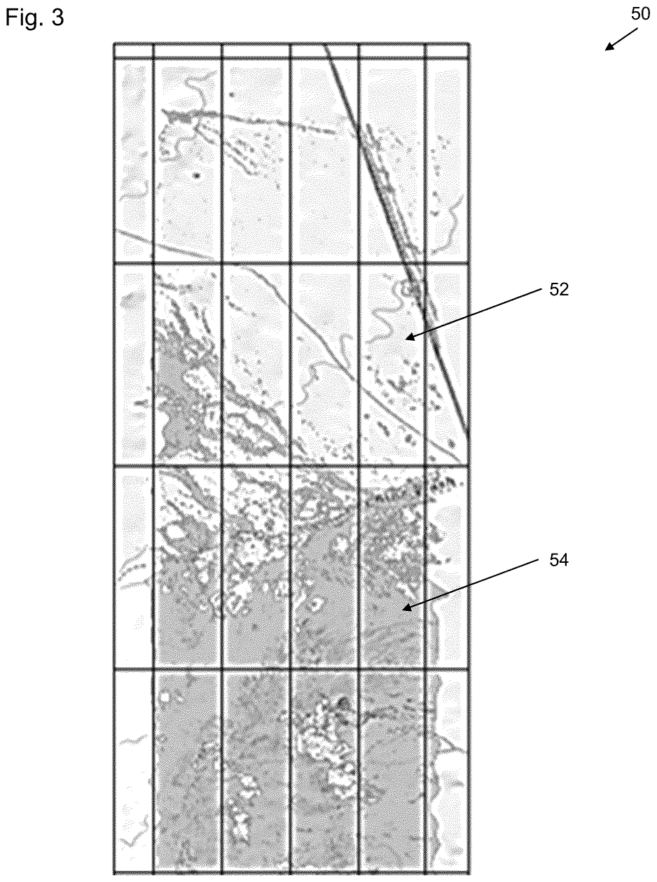

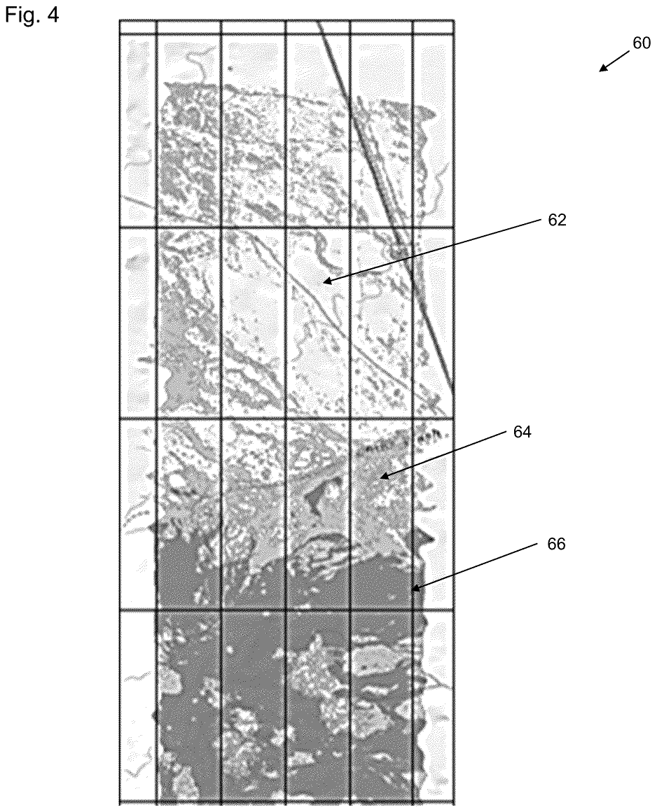

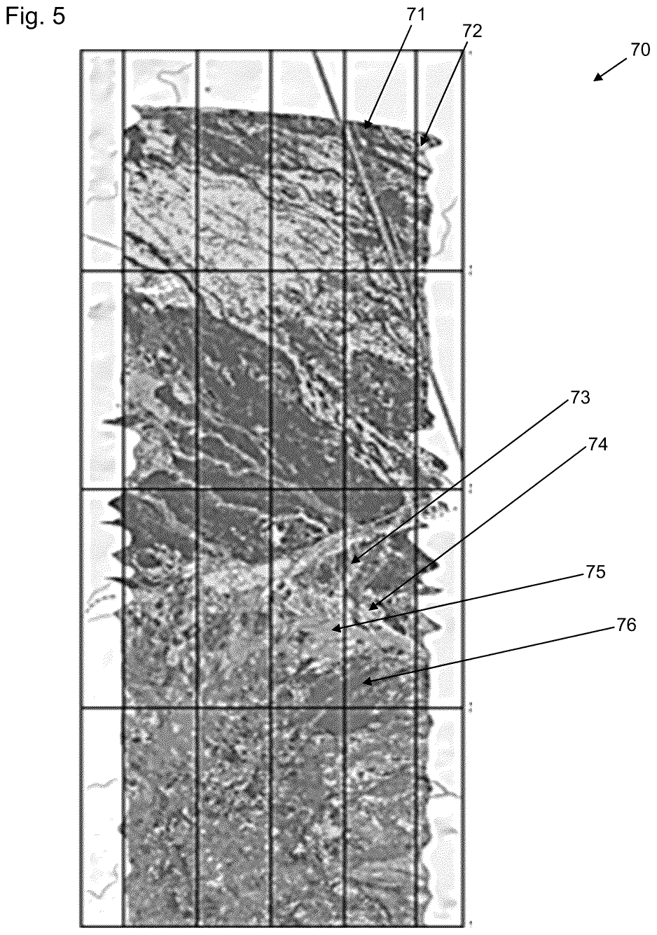

FIGS. 3 through 5 are graphical depictions of spectral images as may be employed and/or produced in accordance with the present disclosure. In image 50 of FIG. 3, different materials 52, 54 are identified and shown in different shading. For example, material 52 can be kaolinite and shown in a lighter shade, whereas material 54 can be kaolinite plus alunite and shown in a darker shade. It will be appreciated that graphical depictions such as images 50, 60 and 70 of FIGS. 3 through 5 can be shown in color with each material type shown in a different color for ease of reading and interpretation. In image 60 of FIG. 4, different materials 62, 64, 66 are identified and shown in different shading. For example, material 62 can be kaolinite and shown in a lighter shade, material 64 can be alunite and shown in a somewhat darker shade than material 62, and material 66 can be kaolinite plus alunite and shown in a darker shade than either material 62 or 64. In image 70 of FIG. 5, different materials 71 through 76 are identified and shown in different shading. For example, material 71 can be montmorillonite, material 72 can be montmorillonite plus calcite, material 73 can be montmorillonite plus muscovite, material 74 can be kaolinite, material 75 can be kaolinite plus muscovite and material 76 can be kaolinite plus alunite plus muscovite, where each material 71-76 is shown in a distinguishing shade or color so as to readily identified visually.

As depicted in FIGS. 3 through 5 and described herein, pixels and/or portions of a display can represent a single material or multiple materials. According to embodiments of the present disclosure, identifying material(s) in every pixel in an image permits mapping of geographic areas for a variety of purposes, including vegetation mapping, mineral mapping and land-use-mapping, for example. In various embodiments, confidence levels can be provided for any and all identified materials, whether identified individually or in combination.

Embodiments of the system 100 and/or device 102 of FIG. 1 execute the approach described above and with regard to FIG. 2, including using a spectral library storing material spectra to determine at least one metric for each pixel in a spectral image using an unmixing model executed on each pixel. The system 100 and/or device 102 can further, for each spectrum from the material spectra in the library, and for each pixel in the spectral image, determine whether to reject the unmixing model based on the stored metric(s). The system 100 and/or device 102 can further define a first region in the spectral image for a first selected spectrum from the spectral library, wherein the first region includes at least one pixel in the spectral image including an associated unrejected unmixing model for the first selected spectrum. The system 100 and/or device 102 can further, for every remaining spectrum beyond the first selected spectrum from the spectral library, define a further region in the spectral image as long as at least one pixel in the spectral image includes an associated unrejected unmixing model and/or can be unmixed with an unrejected unmixing model, wherein the defined further region includes at least one pixel in the spectral image having the associated unrejected unmixing model for the remaining spectrum. The system 100 and/or device 102 can further include an interface in communication therewith, wherein the interface is configured to graphically represent the first region in the spectral image. In various embodiments, the system 100 and/or device 102 can further determine an abundance of the first selected spectrum in each pixel of the first region.

In various embodiments, a first action involves, for each spectrum Sᵢ in the library (where i=0, . . . , N), computing an unmixing model on every pixel in the image recording one or more statics/metrics (for example, likelihood, RMS error, or an information criterion) for each pixel. Such actions can be executed with a graphics processing unit (GPU) as part of apparatus 102, for example. The GPU can include one or more processors to process the unmixing model for a single pixel. In various embodiments, an individual processor is employed to process the unmixing model for each individual pixel such that any given processor processes the unmixing model for no more than one pixel. According to various embodiments, a second action involves, for each spectrum Sᵢ and pixel x in the image, rejecting the model for this spectrum and pixel (call it M[i, x]) if its metrics are low compared to models for this pixel using other spectra. In various embodiments, a third action involves, for each spectrum Sᵢ, creating the region Rᵢ consisting of all pixels x such that the model M[i, x] was not rejected. Iteration can then occur, such as where for each i=1, . . . , N such that Rᵢ is not empty: (a) for j=0, . . . , N, the above repeat the first, second and third actions above on the region Rᵢ: creating a model M[i, j, x] where the model consists of the two spectra Sᵢ and Sⱼ for each x in Rᵢ; (b) reject every model M[i, j, x] whose metrics are low compared to other models for pixel x; and (c) for each i, j, create the region Rᵢⱼ of pixels whose model using Sᵢ and Sⱼ was not rejected. Further iterations can create regions Rᵢⱼₖ, Rᵢⱼₖₗ, etc. of larger models.

Among other things, advantages of the embodiments as disclosed herein include efficiency, where a model M[i, j, x] only gets created if M[i, x] was a good model. Further advantages include GPU-utilization as organizing the creation of models as described above creates the models in batches that can be distributed across the GPU for speed. Moreover, fixing the spectra Sᵢ, Sⱼ (Sⱼ, Sₖ, etc.) means the matrices for the linear or nonlinear regression (with one matrix inversion) can be computed and applied to all x in R. Further advantages include model averaging (or model selection) as the results from the many models for each pixel can be combined using model averaging or refined using model selection. This provides identification of the spectra present in each pixel. Embodiments of the present disclosure can be employed in various situations and scenarios, for example, where identification and unmixing of all pixels in an image are useful, including situations involving vegetation mapping, mineral mapping, land-use-mapping and similar areas.

In certain embodiments in which the system includes a computing device, the computing device is any suitable computing device (such as a server) that includes at least one processor and at least one memory device or data storage device. As further described herein, the computing device includes at least one processor configured to transmit and receive data or signals representing events, messages, commands, or any other suitable information between the computing device and other devices. The processor of the computing device is configured to execute the events, messages, or commands represented by such data or signals in conjunction with the operation of the computing device as exemplified herein.

It will be appreciated that any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing, including a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

It will be appreciated that all of the disclosed methods, components and procedures herein can be implemented using one or more computer programs or components. These components may be provided as a series of computer instructions on any conventional computer-readable medium, including RAM, SATA DOM, or other storage media. The instructions may be configured to be executed by one or more processors which, when executing the series of computer instructions, performs or facilitates the performance of all or part of the disclosed methods and procedures.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed computers and computing devices, for example. In this regard, a processor (e.g., a microprocessor or controller device) receives instructions from a memory or like storage device that contains and/or stores the instructions, and the processor executes those instructions, thereby performing a process defined by those instructions. Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on a user's computer, as a stand-alone software package, partly on a user's computer and partly on a remote computer or entirely on the remote computer or server.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present disclosure, as will be understood to one of ordinary skill in the art.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

1. A computer-implemented method for unmixing pixels in hyperspectral imagery, comprising:
(a) determining, using a spectral library storing a plurality of material spectra, at least one metric for each pixel of a plurality of pixels in a spectral image using an unmixing model executed on each pixel of the plurality of pixels in the spectral image;
(b) for each spectrum of the plurality of material spectra in the library, and for each pixel in the plurality of pixels in the spectral image, determining whether to reject the unmixing model based on the stored at least one metric;
(c) defining a first region in the spectral image for a first selected spectrum from the spectral library, wherein the first region comprises at least one pixel in the spectral image comprising an associated unrejected unmixing model for the first selected spectrum; and
(d) for every remaining spectrum beyond the first selected spectrum from the spectral library, defining a further region in the spectral image as long as at least one pixel in the spectral image can be unmixed with an unrejected unmixing model, wherein the defined further region comprises at least one pixel in the spectral image comprising the associated unrejected unmixing model for the remaining spectrum.

2. The computer-implemented method of claim 1, further comprising determining an abundance of the first selected spectrum in each pixel of the first region.

3. The computer-implemented method of claim 1, wherein the at least one metric comprises at least one of: a root mean square value, and a likelihood value.

4. The computer-implemented method of claim 1, wherein determining whether to reject the unmixing model based on the stored at least one metric in (b) comprises comparing the stored at least one metric for a first spectrum with the stored at least one metric for a second spectrum.

5. The computer-implemented method of claim 4, wherein determining whether to reject the unmixing model based on the stored at least one metric in (b) further comprises rejecting the unmixing model for the first spectrum if the stored at least one metric for the first spectrum indicates a lower likelihood of the presence of the first spectrum than the at least one metric for the second spectrum.

6. The computer-implemented method of claim 1, wherein the at least one metric for each pixel in the spectral image is determined simultaneously.

7. The computer-implemented method of claim 1, further comprising:
(e) determining, using the material spectra in the spectral library other than the first selected spectrum, at least one metric for each pixel in the first region using an unmixing model executed on each pixel of the first region;
(f) for each spectrum of the plurality of material spectra in the library other than the first selected spectrum, and for each pixel in the plurality of pixels in the first region, determining whether to reject the unmixing model based on the stored at least one metric; and
(g) defining a sub-region of the first region for the first selected spectrum and a second selected spectrum from the spectral library, wherein the sub-region comprises at least one pixel in the spectral image comprising an associated unrejected unmixing model for the first selected spectrum and the second selected spectrum.

8. The computer-implemented method of claim 7, further comprising determining an abundance of the first selected spectrum and the second selected spectrum in each pixel of the sub-region.

9. The computer-implemented method of claim 7, wherein the at least one metric for each pixel in the first region is determined simultaneously.

10. The computer-implemented method of claim 7, further comprising:
(h) determining, using the material spectra in the spectral library other than the first selected spectrum and the second selected spectrum, at least one metric for each pixel in the sub-region using an unmixing model executed on each pixel of the sub-region;
(i) for each spectrum of the plurality of material spectra in the library other than the first selected spectrum and the second selected spectrum, and for each pixel in the plurality of pixels in the sub-region, determining whether to reject the unmixing model based on the stored at least one metric; and
(j) defining a partial region of the sub-region for the first selected spectrum, the second selected spectrum and a third selected spectrum from the spectral library, wherein the partial region comprises at least one pixel in the spectral image comprising an associated unrejected unmixing model for the first selected spectrum, the second selected spectrum and a third selected spectrum.

11. A system for unmixing pixels in hyperspectral imagery, comprising:
a processor;
a memory storing a plurality of instructions which, when executed by the processor, cause the processor to:
(a) determine, using a spectral library storing a plurality of material spectra, at least one metric for each pixel of a plurality of pixels in a spectral image using an unmixing model executed on each pixel of the plurality of pixels in the spectral image;
(b) for each spectrum of the plurality of material spectra in the library, and for each pixel in the plurality of pixels in the spectral image, determine whether to reject the unmixing model based on the stored at least one metric;
(c) define a first region in the spectral image for a first selected spectrum from the spectral library, wherein the first region comprises at least one pixel in the spectral image comprising an associated unrejected unmixing model for the first selected spectrum; and
(d) for every remaining spectrum beyond the first selected spectrum from the spectral library, define a further region in the spectral image as long as at least one pixel in the spectral image can be unmixed with an unrejected unmixing model, wherein the defined further region comprises at least one pixel in the spectral image comprising the associated unrejected unmixing model for the remaining spectrum; and
an interface in communication with the processor, wherein the interface is configured to graphically represent the first region in the spectral image.

12. The system of claim 11, wherein the instructions further cause the processor to determine an abundance of the first selected spectrum in each pixel of the first region.

13. The system of claim 11, wherein the at least one metric comprises at least one of: a root mean square value, and a likelihood value.

14. The system of claim 11, wherein the instructions further cause the processor to compare the stored at least one metric for a first spectrum with the stored at least one metric for a second spectrum when determining whether to reject the unmixing model based on the stored at least one metric in (b).

15. The system of claim 11, wherein the instructions further cause the processor to reject the unmixing model for the first spectrum if the stored at least one metric for the first spectrum indicates a lower likelihood of the presence of the first spectrum than the at least one metric for the second spectrum, when determining whether to reject the unmixing model based on the stored at least one metric in (b).

16. The system of claim 11, wherein the at least one metric for each pixel in the spectral image is determined simultaneously.

17. The system of claim 11, wherein the instructions further cause the processor to:
(e) determine, using the material spectra in the spectral library other than the first selected spectrum, at least one metric for each pixel in the first region using an unmixing model executed on each pixel of the first region;
(f) for each spectrum of the plurality of material spectra in the library other than the first selected spectrum, and for each pixel in the plurality of pixels in the first region, determine whether to reject the unmixing model based on the stored at least one metric; and
(g) define a sub-region of the first region for the first selected spectrum and a second selected spectrum from the spectral library, wherein the sub-region comprises at least one pixel in the spectral image comprising an associated unrejected unmixing model for the first selected spectrum and the second selected spectrum.

18. The system of claim 17, wherein the instructions further cause the processor to determine an abundance of the first selected spectrum and the second selected spectrum in each pixel of the sub-region.

19. The system of claim 17, wherein the at least one metric for each pixel in the first region is determined simultaneously.

20. The system of claim 17, wherein the instructions further cause the processor to:
(h) determine, using the material spectra in the spectral library other than the first selected spectrum and the second selected spectrum, at least one metric for each pixel in the sub-region using an unmixing model executed on each pixel of the sub-region;
(i) for each spectrum of the plurality of material spectra in the library other than the first selected spectrum and the second selected spectrum, and for each pixel in the plurality of pixels in the sub-region, determine whether to reject the unmixing model based on the stored at least one metric; and
(j) define a partial region of the sub-region for the first selected spectrum, the second selected spectrum and a third selected spectrum from the spectral library, wherein the partial region comprises at least one pixel in the spectral image comprising an associated unrejected unmixing model for the first selected spectrum, the second selected spectrum and a third selected spectrum.
